(19) United States
(12) Patent Application Publication
(10) Pub. No.: US 2006/0156372 A1
(43) Pub. Date: Jul. 13, 2006

(54) System, method and interface for managing content at a set top box

(75) Inventors: James L. Cansler JR., Pflugerville, TX (US); Philip Ted Kortum, Austin, TX (US); Marc Andrew Sullivan, Austin, TX (US); Alyssa Lenorah Noll Williams, Elmhurst, IL (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, L.P.

(21) Appl. No.: 11/034,223

(22) Filed: Jan. 12, 2005

(51) Int. Cl. H04N 7/173; H04N 7/16

(52) U.S. Cl. 725/134; 725/142; 725/89

(57) ABSTRACT

A method for managing content at a set top box is provided and includes receiving a request to view content and indicating that the content is available for downloading for a predetermined time period. Further, the method includes downloading the content to a memory device within a set top box and indicating that the downloaded content will remain within the memory device for a predetermined time. A device is also provided and includes a housing, a broadband input connection, a broadband output connection, and a processor. The processor includes a computer readable medium and a computer program that includes instructions to display a graphical user interface at a display device. The graphical user interface comprises a ready list, a queue list, and an action list. The ready list includes a list of movies that are available for viewing at the display device and an expiration date for each movie.

### FIELD OF THE INVENTION

The present disclosure relates to set top boxes.

### BACKGROUND

For years, televisions have been a staple of consumer electronics sales. As such, a large majority of households in the United States owns at least one television. Providing content to those televisions is a lucrative business and there are numerous types of television content to choose from. For example, viewers can subscribe to digital broadband television networks and digital satellite television networks in order to receive standard digital television content or high definition television content. In addition, many companies now offer digital video recorders (DVRs) that can be incorporated into standard set top boxes. A DVR can be used to record digital television content transmitted to the set top box.

Managing the television content at the set top box can be difficult. For example, a user may not know which content is available for download or which content is available for viewing after it has been downloaded to the set top box.

Accordingly, there is a need for an improved system and method of managing content at a set top box.

### BRIEF DESCRIPTION OF THE DRAWINGS

The present invention is pointed out with particularity in the appended claims. However, other features are described in the following detailed description in conjunction with the accompanying drawings in which:

FIG. 1 is a block diagram representative of an entertainment system;

FIG. 2 is a general diagram of a set top box;

FIG. 3 is a general diagram of an embodiment of a remote control;

FIG. 4 is a general diagram representative of an embodiment of a graphical user interface that can be used to access movies to be broadcast via the entertainment system of FIG. 1;

FIG. 5 is a general diagram representative of an embodiment of a graphical user interface that can be used to access photos to be displayed via the entertainment system of FIG. 1;

FIG. 6 is a flow chart to illustrate a method of downloading content to a set top box; and

FIG. 7 is a flow chart to illustrate a method of viewing content at a television via a set top box.

### DETAILED DESCRIPTION OF THE DRAWINGS

A method for managing content at a set top box is provided and includes receiving a request to view content. Thereafter, the method includes indicating that the content is available for downloading for a predetermined time period. Further, the method includes downloading the content to a memory device within a set top box and indicating that the downloaded content will remain within the memory device for a predetermined time period.

In a particular embodiment, the method also includes displaying a menu of available content. Additionally, the method includes receiving a content selection and querying a user as to whether selected content is to be downloaded or queued. When queue is selected, a title of the selected content is added to a queue list. In a particular embodiment, the queue list includes at least one title for queued content, a rating of the queued content, a cost of downloading the queued content, and an indication of when the queued content will expire. Also, the queue list can include an indication that the queued content has expired.

In a particular embodiment, when download is selected, a title of the selected content is added to a ready list. The ready list can include at least one title for downloaded content, a rating of the downloaded content, a cost of downloading the downloaded content, and an indication of when the downloaded content will expire.

In a particular embodiment, the method can further comprise receiving a request to view downloaded content. Thereafter, an indication can be sent indicating that the downloaded content can be repeatedly viewed during a predetermined time period. Moreover, selected content can be transmitted to a display device. After the predetermined time period has expired, the selected content is deleted from the memory device.

In another embodiment, a graphical user interface is provided and can be used to manage content at a set top box. The graphical user interface includes a ready list. Further, the ready list can include a list of titles that correspond to movies that are available for viewing, a rating for each movie on the list of titles, a cost for downloading each movie on the list of titles, and an expiration date for each movie on the list of titles.

In yet another embodiment, a device for managing video content is provided. Particularly, the device includes a housing, a broadband input connection that extends from the housing, a broadband output connection that extends from the housing, and a processor. The processor includes a computer readable medium and a computer program that is embedded within the computer readable medium. Additionally, the computer program includes instructions to display a graphical user interface at a display device. The graphical user interface comprises a ready list, a queue list, and an action list. In particular, the ready list includes a list of movies that are available for viewing at the display device and an expiration date for each movie on the ready list.

In still another embodiment, a system for managing video content is provided. The system includes a display device, a remote control device, and a set top box that is coupled to the display device and that is responsive to the remote control device. In a particular embodiment, the set top box includes a housing, a broadband input connection, a broadband output connection, and a processor that is coupled to a computer readable memory. The computer readable memory includes a graphical user interface program that comprises instructions to display a ready list and a queue list. Also, the ready list includes a list of movies that are available for viewing at the display device and an expiration date for each movie on the ready list. Particularly, the expiration date indicates when each movie on the ready list is no longer available for viewing at the display device.

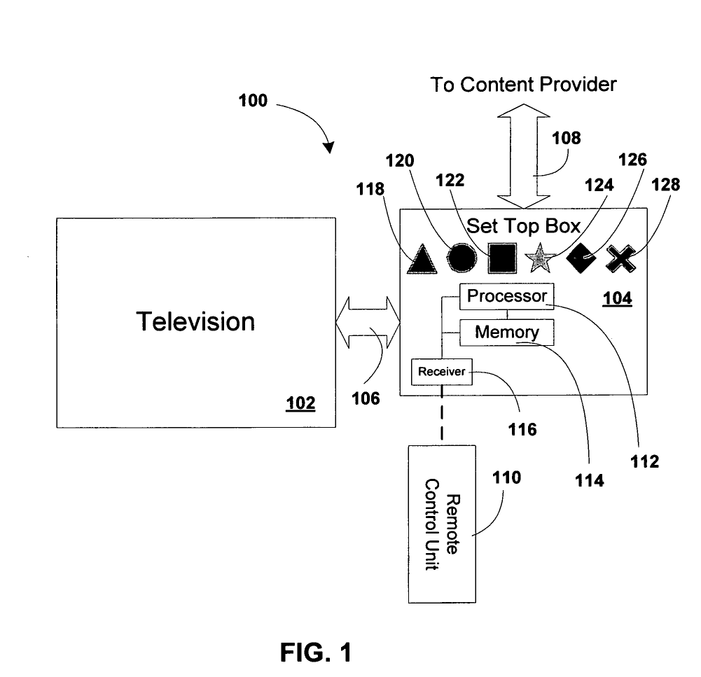

Referring to FIG. 1, a system for managing movies provided at a television is illustrated and is generally designated 100. As illustrated in FIG. 1, in an exemplary, non-limiting embodiment, the system 100 includes a television 102, but it can be appreciated that the system 100 can include any display device on which video content can be displayed. FIG. 1 indicates that a set top box 104 can be connected to the television 102 via a first broadband connection 106. The set top box 104 is also connected to a video content provider, e.g., a cable company or a digital satellite company, via a second broadband connection 108. FIG. 1 also depicts a remote control unit 110 that can communicate with the set top box 104 to allow user interaction with the system 100 during operation. The remote control unit 110 can communicate with the set top box 104 via one or more infrared (IR) signals, radio frequency (RF) signals, or other wireless signals.

As indicated in FIG. 1, the set top box 104 includes a processor 112 in which logic, such as user interface logic, can be executed. Further, the set top box 104 includes a memory 114 in which content from the content provider can be downloaded and stored. FIG. 1 also shows that the set top box 104 can include a receiver 116, e.g., an IR/RF receiver, that is configured to receive one or more IR/IRF signals from the remote control unit 110.

As shown in FIG. 1, the set top box 104 can also include a plurality of service buttons that can be toggled by a user during operation. Specifically, in a particular embodiment, the set top box 104 can include a first button 118 that can be generally triangle-shaped. Further, the set top box 104 can include a second button 120 that can be generally circle-shaped. Also, in a particular embodiment, the set top box 104 can include a third button 122 that can be generally square-shaped. Moreover, the set top box 104 can include a fourth button 124 that can be generally star-shaped. The set top box 104 can also include a fifth button 126 that can be generally diamond-shaped and a sixth button 128 that can be generally x-shaped.

In an illustrative embodiment, the service buttons 118, 120, 122, 124, 126, 128 are arranged in a linear configuration on the set top box 104. Moreover, each service button 118, 120, 122, 124, 126, 128 can have a distinct color. Further, in an illustrative embodiment, the service buttons 118, 120, 122, 124, 126, 128 can correspond to a similarly shaped and colored set of service buttons that are located on the remote control 110 and that are presented as soft keys at different screens of a graphical user interface (GUI) displayed at the television 102. Also, in an illustrative embodiment, the service buttons 118, 120, 122, 124, 126, 128 on the set top box 104 are oriented in the same configuration as corresponding buttons located at the remote control and presented via the GUI.

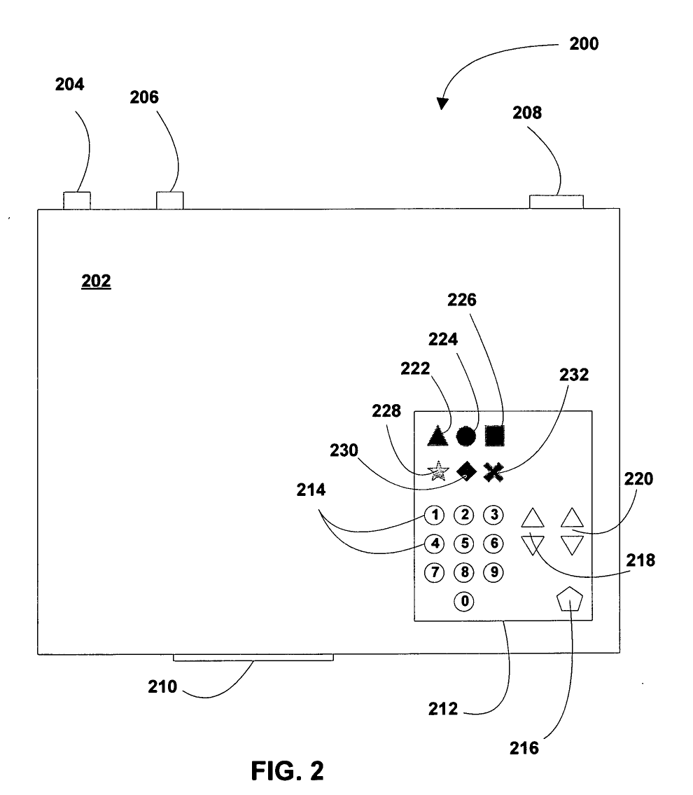

FIG. 2 shows an exemplary, non-limiting embodiment of a set top box, designated 200. As shown, the set top box 200 includes a housing 202. An input 204 and an output 206 extend from the housing 202. In a particular embodiment, the input 204 can be a broadband connection to a content provider. Moreover, the output 206 can be a connection to a television. FIG. 2 further shows a power connection 208 to which a power cord (not shown) from an external power source can be connected. As depicted in FIG. 2, the set top box 200 can further include a display 210. In an illustrative embodiment, the display 210 can be a light emitting diode (LED) display that can be used to indicate to which channel the set top box 200 is tuned. Further the display 210 can be used to indicate the local time.

FIG. 2 indicates that the set top box 200 can include a user interface 212, e.g., a keypad. As shown, the user interface 212 includes a plurality of numbered buttons 214, e.g., from zero to nine, that can be used to tune the set top box 200 to a particular channel. Further, the user interface 212 can include a menu or display button 216 that can be used to present a menu or display at a television connected to the set top box 200. In a particular embodiment, the set top box 200 includes two volume control buttons 218, e.g., a volume up button and a volume down button, that can be used to control the volume of the set top box 200 or another device located near the set top box 200. As illustrated in FIG. 2, the set top box 200 further includes a pair of channel control buttons 220, e.g., a channel up button and a channel down button, that can be used to move linearly, up or down, through the channels provided by the set top box 200.

In a particular embodiment, the set top box 200 includes a plurality of service buttons that correspond to soft keys that can be displayed at a television connected to the set top box 200, e.g., via a graphical user interface. Specifically, the set top box 200 can include a generally triangle-shaped first button 222, a generally circle-shaped second button 224, a generally square-shaped third button 226, a generally star-shaped fourth button 228, a generally diamond-shaped fifth button 230 and a generally x-shaped sixth button 232. As shown in FIG. 2, the numerical keypad 212 and the buttons therein are located on the top of the housing 202. However, the numerical keypad 212 can be located on the front of the housing 202, either side of the housing 202, or the back of the housing 202.

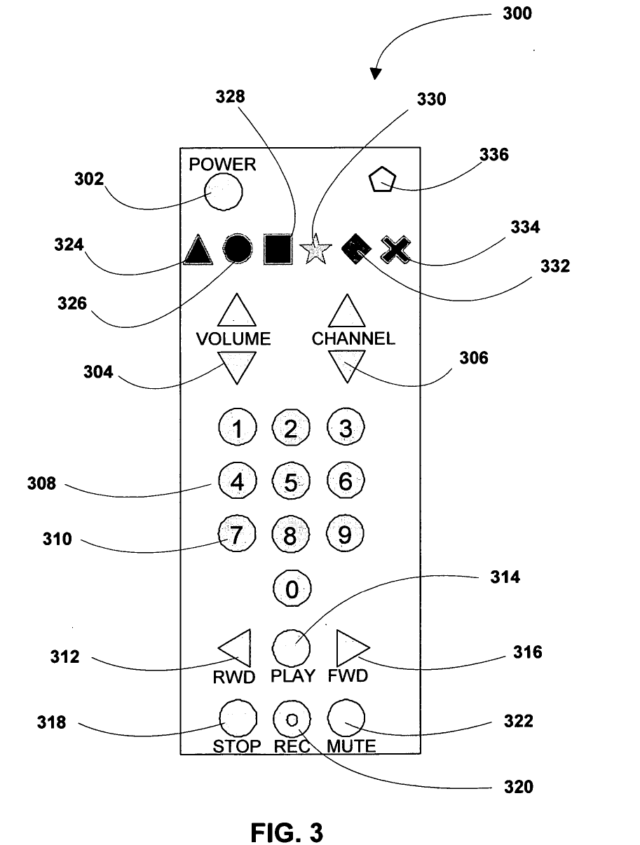

Referring to FIG. 3, an exemplary, non-limiting embodiment of a remote control device is shown and is generally designated 300. As shown, the remote control device 300 includes a power button 302 that can be used to turn the set top box 104 (FIG. 1) on and off. Moreover, the remote control device 300 includes two volume control buttons 304, e.g., a volume up button and a volume down button, that can be used to control the volume of the set top box 104 (FIG. 1) or the television 102 (FIG. 1). As illustrated in FIG. 3, the remote control device 300 further includes a pair of channel control buttons 306, e.g., a channel up button and a channel down button, that can be used to move linearly, up or down, through the channels provided by the set top box 104 (FIG. 1).

FIG. 3 also indicates that the remote control device can include a numerical keypad 308 that includes ten buttons 310 numbered from zero to nine. The numerical keypad 308 can be used to input a channel number to the set top box 104 (FIG. 1). As further illustrated in FIG. 3, the remote control device 300 can include a rewind button 312, a play button 314, a forward button 316, a stop button 318, a record button 320, and a mute button 322. In an illustrative embodiment, these buttons 312, 314, 316, 318, 320, 322 can be used to control a digital video recorder (DVR) within the set top box 104 (FIG. 1), a digital video disc (DVD) player near the set top box 104 (FIG. 1), a video cassette recorder (VCR) near the set top box 104 (FIG. 1), etc.

FIG. 3 further illustrates that the remote control device 300 further includes a plurality of service buttons that are located in a portion of the remote control device 300 that is dedicated solely to the service buttons. Specifically, in a particular embodiment, the remote control device 300 can include a generally triangle-shaped first button 324. Further, the remote control device 300 can include a generally circle-shaped second button 326. Also, in a particular embodiment, the remote control device 300 can include a generally square-shaped third button 328. Moreover, the remote control device 300 can include a generally star-shaped fourth button 330. The remote control device 300 can also include a generally diamond-shaped fifth button 332 and a generally x-shaped sixth button 334. As shown in FIG. 3, the service buttons 324, 326, 328, 330, 332, 334 on the remote control device 300 are oriented in the same linear configuration as the service buttons 118, 120, 122, 124, 126, 128 (FIG. 1) on the set top box 104 (FIG. 1) and have the same spatial arrangement as the service buttons 118, 120, 122, 124, 126, 128 (FIG. 1) on the set top box 104 (FIG. 1). Moreover, each service button 324, 326, 328, 330, 332, 334 on the remote control device 300 can be the same color as the similarly shaped button 118, 120, 122, 124, 126, 128 (FIG. 1) on the set top box 104 (FIG. 1). FIG. 3 further shows that the remote control device 300 includes a menu/display button 336 that can be pressed in order to cause a graphical user interface (GUI), e.g., one of the GUIs described below, to be displayed at the television 102 (FIG. 1).

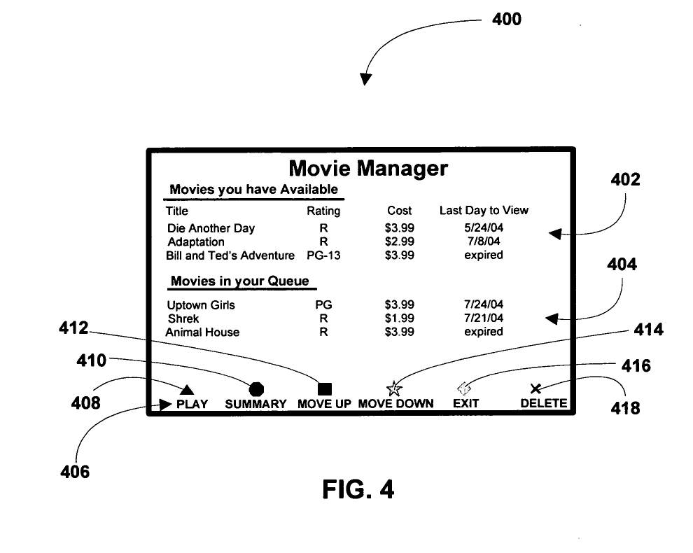

FIG. 4 depicts an exemplary, non-limiting embodiment of a graphical user interface (GUI), generally designated 400, that can be presented to a user at the television 102 (FIG. 1) during operation of the system 100. In one embodiment, the GUI 400 is a content management GUI and can include a ready list 402, a queue list 404, and an action list 406. The ready list 402 can contain a list of movie titles that correspond to video files that have been downloaded to the set top box 104 (FIG. 1), e.g., to the memory 114 (FIG. 1), and that are available to be viewed at the television 102 (FIG. 1). Moreover, the ready list 402 can include a brief description of each movie title. For example, the ready list 402 can include information concerning the rating of the movie, e.g., G, PG, R, NR, etc., the cost to download the movie, and the last day to view the movie.

It can be appreciated that the video files corresponding to the movie titles presented by the ready list may or may not be completely downloaded to the memory 114 (FIG. 1) within the set top box 104 (FIG. 1) if streaming video is supported. If streaming video is supported by the system 100 (FIG. 1), the presence of a title in the ready list 402 may indicate that a sufficient portion of the corresponding video file has been downloaded into a buffer portion of the memory for video streaming to commence. The presence of a particular movie title can also indicate that the corresponding video file has been downloaded in its entirety to the memory 114 (FIG. 1) of the set top box 104 (FIG. 1). In an illustrative embodiment, the GUI 400 can include icons or text to indicate to a user whether a particular video file is going to be streamed or fully downloaded.

Further, in a particular embodiment, the queue list 404 can contain a list of movie titles that correspond to video files that a user wishes to see at some later date or time. The queue list 404 can also include information regarding the movie titles presented therein, e.g., ratings, prices, and viewing status. In an exemplary, non-limiting embodiment, the top item on the queue list 404 can be downloaded and moved to the ready list 402 when space in the ready list 402 becomes available, e.g., after a movie title has been deleted from the ready list 402 and the corresponding video file has been deleted from the memory 114 (FIG. 1). It can be appreciated that in addition to showing the movies that are to be downloaded, the queue list 404 can also serve as a wish list for a user. In other words, a user can add a number of other movie titles to the queue list 404 in order to help keep track of the movies that the user may want to view at a later time.

As illustrated in FIG. 4 and in an exemplary, non-limiting embodiment, the action list 406 can include a plurality of soft keys that a user can use to accomplish certain tasks using the remote control unit 300 (FIG. 3), e.g., by toggling one of the service buttons 324, 326, 328, 330, 332, 334 (FIG. 3) included on the remote control unit 300 (FIG. 3) or one of the service buttons 118, 120, 122, 124, 126, 128 (FIG. 1) included in the set top box 100 (FIG. 1). FIG. 4 shows that the action list 406 can include a generally triangle-shaped soft key 408 that is labeled “play”, a generally circle-shaped soft key 410 that is labeled “summary”, a generally square-shaped soft key 412 that is labeled “move up”, a generally star-shaped soft key 414 that is labeled “move down”, a generally diamond-shaped soft key 416 that is labeled “exit”, and a generally x-shaped soft key 418 that is labeled “delete”.

In a particular embodiment, the soft keys 408, 410, 412, 414, 416, 418 presented in the action list 406 have the same spatial arrangement and are oriented in the same linear configuration as the service buttons 118, 120, 122, 124, 126, 128 (FIG. 1) on the set top box 104 (FIG. 1) and the service buttons 324, 326, 328, 330, 332, 334 (FIG. 3) on the remote control device 300 (FIG. 3). Moreover, each of the soft keys 408, 410, 412, 414, 416, 418 can be the same color as each similarly shaped service button 324, 326, 328, 330, 332, 334 (FIG. 3) on the remote control device 300 (FIG. 3) and each similarly shaped button 118, 120, 122, 124, 126, 128 (FIG. 1) on the set top box 104 (FIG. 1).

Further, in a particular embodiment, the labels attached to the soft keys indicate the functionality of each soft key. For example, when the “play” soft key 408 is selected, a video file can be broadcast to the television 102 (FIG. 1), e.g., from the memory 114 (FIG. 1) in the set top box 104 (FIG. 1). The “summary” soft key 410 can be selected in order to present summary information to a user, e.g., summary information about video files downloaded or video files scheduled to be downloaded. In another embodiment, these tasks can be accomplished using the correspondingly shaped and colored service buttons 118, 120, 122, 124, 126, 128 that are located at the set top box 104 (FIG. 1).

In an illustrative embodiment, the “move up” soft key 412 and the “move down” soft key 414 can be toggled, or otherwise selected, in order to navigate through the GUI 400, e.g., to select a movie title for viewing or downloading. In another embodiment, a user can highlight a movie title in the queue list 404 and then, use the “move up” soft key 412 or the “move down” soft key 414 in order to change the position of the highlighted movie title in the queue list 404. The “exit” soft key 416 can be selected, e.g., to exit the movie manager 400 shown in FIG. 4. Further, the “delete” soft key 418 can be selected, e.g., to delete a movie title from the ready list 402 or the queue list 404. It can be appreciated that the action list 406 can include other keys for added functions other than those shown. For example, the action list 406 can also include a browse key, a rent key, a set password key, and an information key.

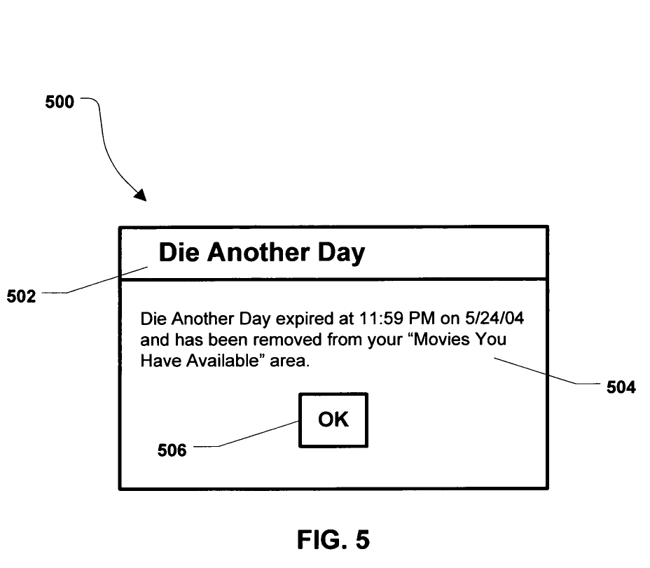

FIG. 5 shows a non-limiting, exemplary embodiment of a GUI designated 500. In a particular embodiment, the GUI 500 is a delete content GUI and includes a title field 502, a message field 504, and an acknowledgement button 506. Particularly, the title field 502 indicates the title of a particular content item, e.g., a movie, that is being deleted. Further, the message field 504 can be an indication that the particular content item will expire and will be removed from the ready list 402 (FIG. 4) presented at the content management GUI 400 (FIG. 4). Alternatively, the message field 504 can be an indication that the particular content has expired and has been removed from the ready list 402 (FIG. 4). Additionally, in a particular embodiment, the acknowledgement button 506 is a soft button that is labeled “OK” and a user can acknowledge when a particular content item has expired and has been removed from the ready list 402 (FIG. 4) at the content management GUI 400 (FIG. 4).

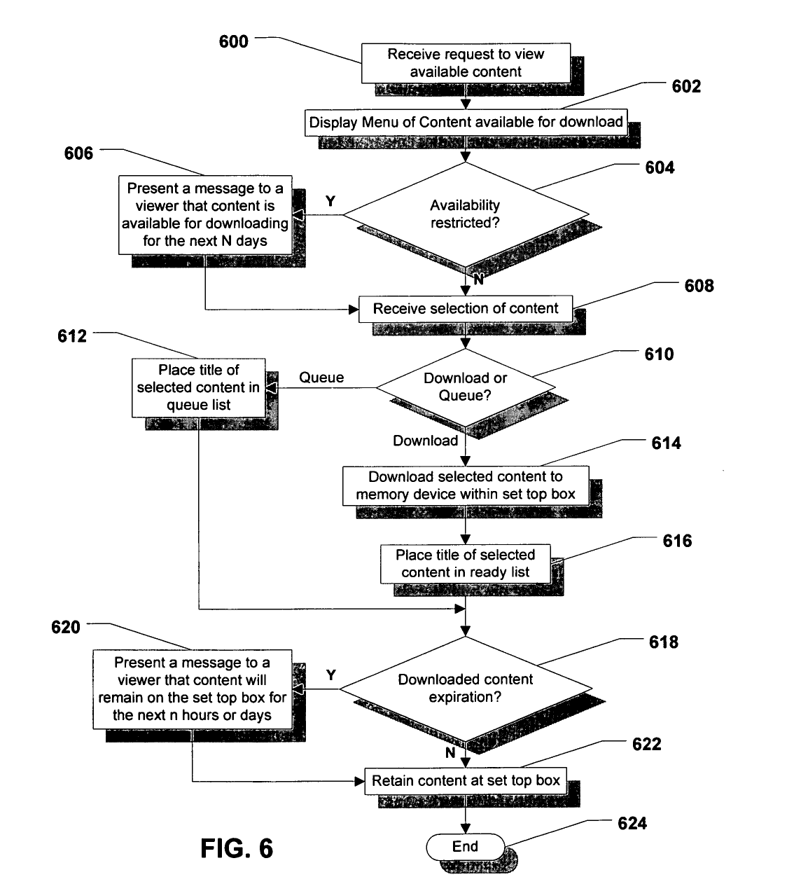

Referring now to FIG. 6, a method of downloading content to a set top box is shown and commences at block 600 when a user purchases content and requests to view the content via the set top box. For example, the content can be a pay-per-view movie. In a particular embodiment, the user can be charged when the content is downloaded. However, in an alternative embodiment, the use can be charged when he or she begins to view downloaded content. Moving to block 602, the set top box displays a menu of content that is available for download. Next, at decision step 604, the set top box determines whether download of the purchased content is restricted. If so, the method proceeds to block 606 and the set top box presents a message to a viewer, e.g., via a television, that the content is available for downloading for the next N days. In a particular embodiment, the content may be available for downloading for thirty days after it is purchased. Then, the method moves to block 608. Returning to decision step 604, if the download of the purchased content is not restricted, the method also proceeds to block 608.

At block 608, the set top box receives a selection of content from the user. At decision step 610, the set top box queries the user as to whether the selected content should be downloaded to the set top box or queued for later download to the set top box. If the user wants to queue the selected content, the selected content is placed in a queue at the set top box at block 612. On the other hand, if the user wants to download the selected content, the method moves to block 614 and the selected content is downloaded to a memory device within the set top box. Moving to block 616, the set top box places the title of the selected content in the ready list.

Next, at decision step 618, the set top box determines whether viewing of the downloaded content is restricted. If so, the set top box presents a message to a viewer that content is available for viewing for the next N hours or N days at block 620. In a particular embodiment, once the content is downloaded to the set top box, the user may view the content an unlimited number of times within a predetermined time period such as twenty four hours, two days, three days, four days, five days, a week, etc. The logic then continues to block 622. As illustrated in FIG. 6, block 622 can also be reached from decision step 618 if viewing of the downloaded content is not restricted. At block 622, the downloaded content is retained at the set top box. The logic then ends at state 624.

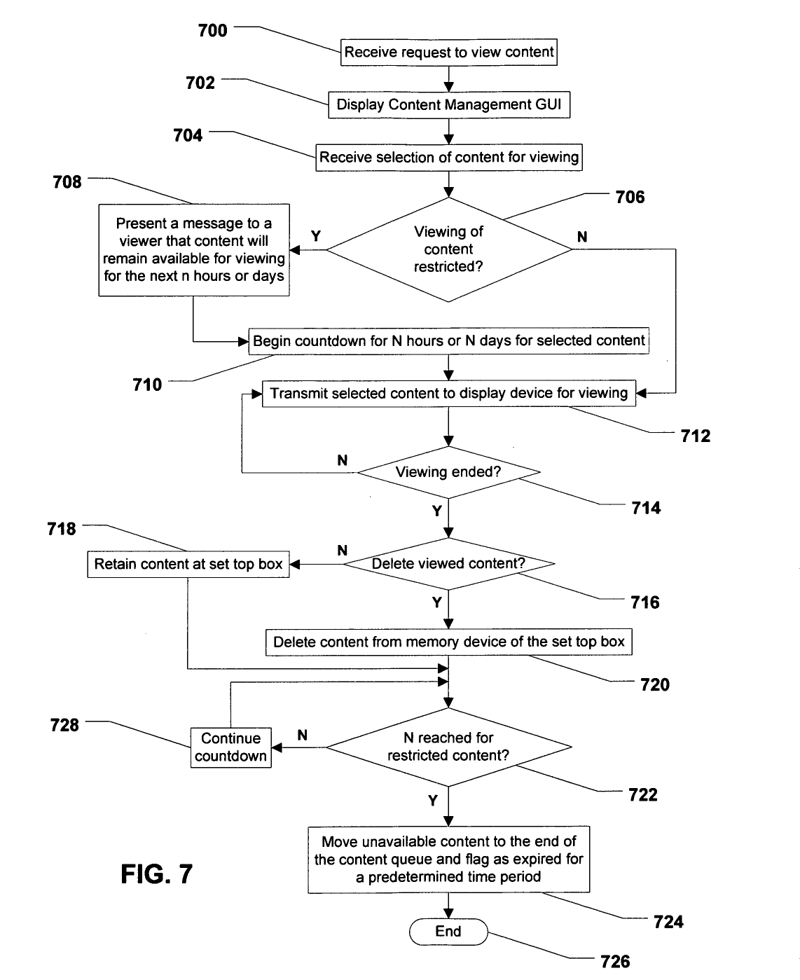

FIG. 7 shows a method of viewing content at a television via a set top box. Commencing at block 700, a user requests content via the set top box. At block 702, the set top box displays a menu of content that is available for viewing at a television that is connected to the set top box. Moving to block 704, the set top box receives a selection of content for viewing from the user. At decision step 706, the set top box determines whether viewing of the selected content is restricted. If so, the logic proceeds to block 708 and the set top box presents a message to a viewer that the content will remain available for viewing for the next N hours or N days. Next, at block 710, the set top box begins a countdown for N hours or N days for the selected content. The method then proceeds to block 712.

Returning to decision step 706, if viewing of the selected content is not restricted, the method also proceeds to block 712 and the selected content is transmitted to a television or other display device for viewing. Thereafter, at decision step 714, the set top box determines if the viewing of the content has ended. If not, the logic returns to block 712 and the selected content continues to be transmitted to the television. If the viewing of the content has ended, the method continues to decision step 716 and the set top box queries the viewer to determine whether the viewed content should be deleted. If the viewer does not want to delete the content, the method proceeds to block 718 and the content is retained at the set top box. On the other hand, if the viewer wants to delete the content, the method moves to block 720 and the content is deleted from the memory of the set top box.

From block 718 or from block 720, the method continues to decision step 722 and the set top box determines whether N has been reached for any restricted content, e.g., any content that has been downloaded and can only be viewed for a predetermined time period. If N has been reached, the method continues to block 724 and the set top box moves the unavailable content to the end of the content queue and flags the content as expired for a predetermined time period, e.g., one or more days. The method then ends at state 726. If N has not been reached, the method proceeds to block 728 and the countdown for any restricted content that has been downloaded continues. The logic then returns to decision step 722 and continues as described above.

With the configuration of structure described above, the system, method and graphical user interface can provide a user-friendly and intuitive means for managing and viewing movies and other content via a set-top box. Moreover, the system, method and graphical user interface can provide added functionality with respect to the management of those movies. For example, the interface can provide an indication that content is no longer available for download or an indication that content is no longer available for viewing.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method for managing content at a set top box, the method comprising:
receiving a request to view content;
indicating that the content is available for downloading for a predetermined time period;
downloading the content to a memory device within a set top box; and
indicating that the downloaded content will remain within the memory device for a predetermined time period.

2. The method of claim 1, further comprising displaying a menu of available content.

3. The method of claim 2, further comprising receiving a content selection.

4. The method of claim 3, further comprising querying a user as to whether selected content is to be downloaded or queued.

5. The method of claim 4, further comprising adding a title of the selected content to a queue list.

6. The method of claim 5, wherein the queue list includes at least one title for queued content, a rating of the queued content, a cost of downloading the queued content, and an indication of when the queued content will expire.

7. The method of claim 6, wherein the queue list further includes an indication that the queued content has expired.

8. The method of claim 4, further comprising adding a title of the selected content to a ready list.

9. The method of claim 8, wherein the ready list includes at least one title for downloaded content, a rating of the downloaded content, a cost of downloading the downloaded content, and an indication of when the downloaded content will expire.

10. The method of claim 1, further comprising receiving a request to view downloaded content.

11. The method of claim 10, further comprising indicating that the downloaded content can be repeatedly viewed during a predetermined time period.

12. The method of claim 11, further comprising transmitting selected content to a display device.

13. The method of claim 12, further comprising deleting the selected content from the memory device after the predetermined time period has expired.

14. A graphical user interface for managing content at a set top box, the graphical user interface comprising:
a ready list comprising:
a list of titles that correspond to movies that are available for viewing;
a rating for each movie on the list of titles;
a cost for downloading each movie on the list of titles; and
an expiration date for each movie on the list of titles.

15. The graphical user interface of claim 14, wherein the expiration date for each movie on the list of titles indicates when each movie can no longer be viewed at a display device coupled to the set top box.

16. The graphical user interface of claim 15, further comprising a queue list comprising a list of movies.

17. The graphical user interface of claim 16, further comprising a rating for each movie on the queue list.

18. The graphical user interface of claim 17, further comprising a cost of downloading each movie on the queue list.

19. The graphical user interface of claim 18, further comprising an expiration date for each movie on the queue list.

20. The graphical user interface of claim 19, wherein the expiration date for each movie on the queue list indicates when each movie on the queue list is no longer available to be downloaded to the set top box.

21. A device for managing video content, the device comprising:
a housing;
a broadband input connection extending from the housing;
a broadband output connection extending from the housing;
a processor, the processor comprising a computer readable medium and a computer program embedded within the computer readable medium, the computer program comprising:
instructions to display a graphical user interface at a display device, the graphical user interface comprising a ready list, a queue list, and an action list, wherein:
the ready list comprises a list of movies that are available for viewing at the display device and an expiration date for each movie on the ready list.

22. The device of claim 21, wherein the expiration date for each movie on the ready list indicates when each movie on the ready list can no longer be viewed at the display device.

23. The device of claim 22, wherein the queue list comprises a list of movies that a user may want to download at a future time and an expiration date for each movie on the queue list.

24. The device of claim 23, wherein the expiration date for each movie on the queue list indicates when each movie on the queue list is no longer available to be downloaded.

25. A system for managing video content, the system comprising:
a display device;
a remote control device;
a set top box coupled to the display device and responsive to the remote control device, the set top box comprising:
a housing;
a broadband input connection;
a broadband output connection;
a processor, the processor coupled to a computer readable memory, the computer readable memory comprising:
a graphical user interface program comprising:
instructions to display a ready list and a queue list, wherein:
the ready list includes a list of movies that are available for viewing at the display device and an expiration date for each movie on the ready list, the expiration date indicating when each movie on the ready list is no longer available for viewing at the display device.

26. The system of claim 25, wherein the queue list comprises a list of movies a user may want to download at a future time and an expiration date for each movie on the queue list, the expiration date indicating when each movie on the queue list is no longer available for downloading to the set top box.

27. The system of claim 25, further comprising a computer program embedded within the computer readable memory, the computer program comprising instructions to receive a request to view available content.

28. The system of claim 27, wherein the computer program further comprises instructions to indicate that the available content is available for downloading for a predetermined time period.

29. The system of claim 28, wherein the computer program further comprises instructions to receive content at the computer readable memory.

30. The system of claim 29, wherein the computer program further comprises instructions to indicate that downloaded content will remain within a memory device for a predetermined time period.

31. The system of claim 30, wherein the computer program further comprises instructions to indicate that the downloaded content can be repeatedly viewed for a predetermined time period after the downloaded content is initially viewed.

32. The system of claim 31, wherein the computer program further comprises instructions to delete the downloaded content from the memory device after a predetermined time period expires.
